(19) United States
(12) Patent Application Publication
(10) Pub. No.: US 2025/0046845 A1
(43) Pub. Date: Feb. 6, 2025

(54) FLOW BATTERY CLEANING APPARATUS, METHOD, AND SYSTEM

(71) Applicant: VRB Energy Inc., Grand Cayman (KY)

(72) Inventors: Yongkai Han, Beijing (CN); Shuai Dong, Beijing (CN); Dehao Wang, Beijing (CN); Zhiwei Duan, Beijing (CN); Hedi Ma, Beijing (CN); Huichao Liu, Beijing (CN); Qiming Ge, Beijing (CN)

(21) Appl. No.: 18/756,901

(22) Filed: Jun. 27, 2024

(30) Foreign Application Priority Data
Aug. 2, 2023 (CN) 202310962028.2

(51) Int. Cl. H01M 8/18; H01M 8/04186

(52) U.S. Cl. CPC H01M 8/188; H01M 8/04186

(57) ABSTRACT

Provided are a flow battery cleaning apparatus, method, and system. A flow battery includes: a positive electrode liquid tank, a negative electrode liquid tank, and a stack unit, the positive electrode liquid tank and the stack unit forming a positive electrode circulation loop, and the negative electrode liquid tank and the stack unit forming a negative electrode circulation loop. The flow battery cleaning apparatus includes a detection apparatus, a first foreign matter removal apparatus, and a second foreign matter removal apparatus, and the detection apparatus includes a first detection apparatus. The first detection apparatus is configured to detect whether foreign matter is present in the stack unit, the first foreign matter removal apparatus is configured to adjust the pressure of the positive electrode circulation loop, and the second foreign matter removal apparatus is configured to adjust the pressure of the negative electrode circulation loop.

### RELATED APPLICATIONS

This application claims priority to Chinese Patent Application No. 202310962028.2, filed Aug. 2, 2023, and titled FLOW BATTERY CLEANING APPARATUS, METHOD, AND SYSTEM, which is incorporated herein by reference in its entirety.

### BACKGROUND

With the development of society and the economy, the demand for new energy is increasing, which promotes the development of the energy storage industry. A flow battery achieves the mutual conversion of electric energy and chemical energy by means of a reversible redox reaction (i.e., the reversible change in valence) between active species of positive and negative electrolytes. Due to good stability and safety, flow batteries have become a mainstream technical solution in the field of energy storage.

Through research, the inventors of the present application have found that the stack unit of the flow battery is easily blocked by foreign matter such as crystals.

### SUMMARY

The following is a summary of the subject matter described in detail herein. This summary is not intended to limit the scope of protection of the claims.

Embodiments of the present application provide a flow battery cleaning apparatus, method, and system, which can solve the problem that a stack unit of a flow battery is easily blocked by foreign matter such as crystals.

According to a first aspect, embodiments of the present application provide a flow battery cleaning apparatus, wherein a flow battery comprises: a positive electrode liquid tank, a negative electrode liquid tank, and a stack unit, the positive electrode liquid tank and the stack unit forming a positive electrode circulation loop, and the negative electrode liquid tank and the stack unit forming a negative electrode circulation loop; characterized in that the flow battery cleaning apparatus comprises: a detection apparatus, a first foreign matter removal apparatus, and a second foreign matter removal apparatus, and the detection apparatus comprises a first detection apparatus. The first detection apparatus is configured to detect whether foreign matter is present in the stack unit, the first foreign matter removal apparatus is configured to adjust the pressure of the positive electrode circulation loop, and the second foreign matter removal apparatus is configured to adjust the pressure of the negative electrode circulation loop.

In an exemplary embodiment, the first detection apparatus is configured to detect whether foreign matter is present in the stack unit every time a first time period elapses.

In an exemplary embodiment, the detection apparatus further comprises a second detection apparatus and a third detection apparatus. The second detection apparatus is configured to detect a first pressure value of the positive electrode circulation loop, and the third detection apparatus is configured to detect a second pressure value of the negative electrode circulation loop. The first foreign matter removal apparatus is configured to adjust the pressure of the positive electrode circulation loop to a third pressure value when the first pressure value is less than a first threshold, the third pressure value being greater than the first pressure value and less than the first threshold. The second foreign matter removal apparatus is configured to adjust the pressure of the negative electrode circulation loop to a fourth pressure value when the second pressure value is less than the first threshold, the fourth pressure value being greater than the second pressure value and less than the first threshold.

In an exemplary embodiment, the flow battery cleaning apparatus further comprises a first switch and a second switch. The first switch is disposed on the positive electrode circulation loop and configured to open or close the positive electrode circulation loop, and the second switch is disposed on the negative electrode circulation loop and configured to open or close the negative electrode circulation loop.

In an exemplary embodiment, the flow battery cleaning apparatus further comprises a first filter apparatus and a second filter apparatus. The first filter apparatus is connected to the positive electrode circulation loop and configured to prevent the foreign matter from entering the positive electrode liquid tank, and the second filter apparatus is connected to the negative electrode circulation loop and configured to prevent the foreign matter from entering the negative electrode liquid tank.

In an exemplary embodiment, the detection apparatus further comprises a fourth detection apparatus. The fourth detection apparatus is configured to detect whether the operating state of the flow battery is normal before the first detection apparatus detects whether foreign matter is present in the stack unit.

In an exemplary embodiment, the flow battery cleaning apparatus further comprises a display apparatus. The display apparatus is configured to display whether the operating state of the flow battery is normal according to the detection result of the fourth detection apparatus.

In an exemplary embodiment, the flow battery cleaning apparatus further comprises an automatic control apparatus. The automatic control apparatus is configured to control the first foreign matter removal apparatus, the second foreign matter removal apparatus, and the display apparatus to operate according to the detection result of the detection apparatus.

According to a second aspect, embodiments of the present application provide a flow battery cleaning method, wherein a flow battery comprises: a positive electrode liquid tank, a negative electrode liquid tank, and a stack unit, the positive electrode liquid tank and the stack unit forming a positive electrode circulation loop, and the negative electrode liquid tank and the stack unit forming a negative electrode circulation loop. The method comprises: using a first detection apparatus to detect whether foreign matter is present in the stack unit; using a first foreign matter removal apparatus to remove foreign matter located in the positive electrode circulation loop, the first foreign matter removal apparatus being configured to adjust the pressure of the positive electrode circulation loop; and using a second foreign matter removal apparatus to remove foreign matter located in the negative electrode circulation loop, the second foreign matter removal apparatus being configured to adjust the pressure of the negative electrode circulation loop.

According to a third aspect, embodiments of the present application further provide a flow battery cleaning system, comprising a flow battery and the flow battery cleaning apparatus described above.

In the flow battery cleaning apparatus provided by the embodiments of the present application, when the first detection apparatus detects that foreign matter is present in the stack unit, the pressure of the positive electrode circulation loop is adjusted by the first foreign matter removal apparatus, and the pressure of the negative electrode circulation loop is adjusted by the second foreign matter removal apparatus, so that the scouring strength of an electrolyte in the circulation loop to which it belongs can be increased, and thus the foreign matter in the stack unit can be cleaned out. The flow battery cleaning apparatus provided by the embodiments of the present application can promptly detect and clean out foreign matter such as crystals in the stack unit, so that the probability of a blockage occurring in the stack unit can be reduced, long-term stable operation of the flow battery can be ensured, and the maintenance costs of the flow battery can be reduced. The problem that the stack unit of the flow battery is easily blocked by foreign matter such as crystals is solved.

Other features and advantages of the present application will be set forth in the following description, and in part will become apparent from the description, or may be understood by means of the implementation of the present application. Other advantages of the present application will be achieved and attained by means of the solutions described in the description and the accompanying drawings.

Other aspects will become apparent upon reading and understanding the accompanying drawings and the detailed description.

### BRIEF DESCRIPTION OF THE DRAWINGS

The accompanying drawings are used to provide an understanding of the technical solutions of the present application and constitute a part of the specification, and together with the embodiments of the present application, are used to explain the technical solution of the present application and not to limit the technical solution of the present application.

FIG. 1 is a schematic diagram of a flow battery;

FIG. 2 is a schematic diagram of a flow battery cleaning apparatus in an exemplary embodiment; and

FIG. 3 is a schematic diagram of a cleaning process using the flow battery cleaning apparatus shown in FIG. 2 in an exemplary embodiment.

### DETAILED DESCRIPTION

Several embodiments are described in the present application, but the description is illustrative rather than limiting, and it will be apparent to those of ordinary skill in the art that more embodiments and implementations are possible within the scope encompassed by the embodiments described in the present application. Although many possible combinations of features are shown in the accompanying drawings and discussed in the detailed description, many other combinations of the disclosed features are possible. Any feature or element in any embodiment may be used in combination with or may replace any other features or elements in any other embodiments unless specifically limited.

Embodiments of the present application include and contemplate combinations with features and elements known to those of ordinary skill in the art. The embodiments, features and elements disclosed in the present application may also be combined with any conventional feature or element to form a unique inventive solution as defined by the claims. Any feature or element in any embodiment may also be combined with features or elements from other inventive solutions to form another unique inventive solution as defined by the claims. Therefore, it should be understood that any of the features shown and/or discussed in the present application may be implemented separately or in any suitable combination. Therefore, the embodiments are not limited except as made by the appended claims and equivalents thereof. Furthermore, various modifications and changes can be made within the scope of protection of the appended claims.

Furthermore, in describing representative embodiments, the specification may have presented the method and/or process as a particular sequence of steps. However, to the extent that the method or process does not depend on the particular order of steps described herein, the method or process should not be limited to the particular order of steps. As will be appreciated by those of ordinary skill in the art, other orders of steps are possible. Therefore, the particular order of steps set forth in the specification should not be construed as limiting the claims. Furthermore, the claims relating to the method and/or process should not be limited to performing their steps in the written order, and those skilled in the art can readily understand that these orders may vary and still remain within the spirit and scope of the embodiments of the present application.

A flow battery is a high-performance battery in which positive and negative electrolytes are separated and circulated separately. The electrolytes include active species, and the active species flow with the positive and negative electrolytes and undergo a reversible redox reaction, so that the flow battery completes charging and discharging processes. The flow battery may be classified into a vanadium redox flow battery, an iron-chromium flow battery, a zinc-bromine flow battery, a sodium polysulfide/bromine flow battery, a zinc/nickel flow battery, and the like according to different active species included in the electrolytes. As electrochemical energy storage technology, the flow battery has the characteristics of high capacity, wide application range, long cycle life, and the like.

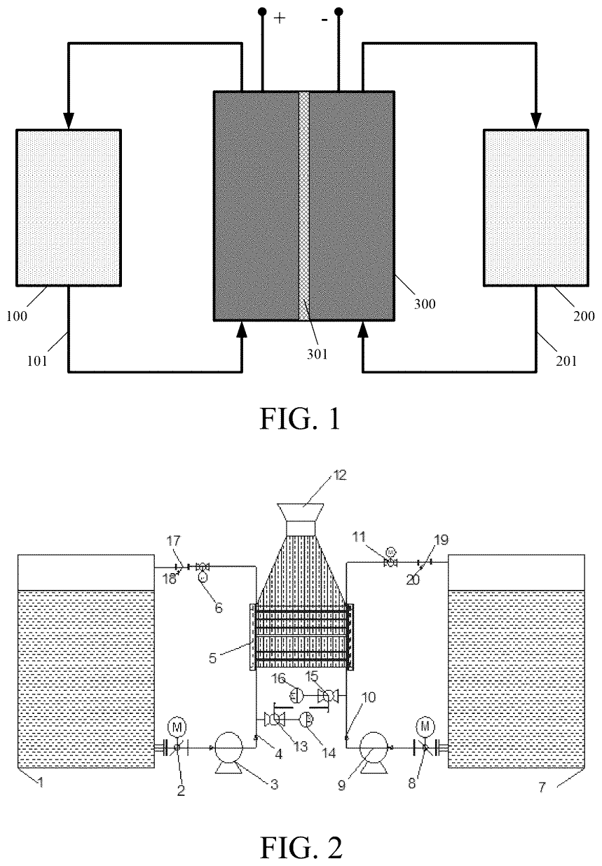

FIG. 1 is a schematic diagram of a flow battery. As shown in FIG. 1, the flow battery includes a positive electrode liquid tank 100, a negative electrode liquid tank 200, and a stack unit 300. The positive electrode liquid tank 100 contains a positive electrolyte, the positive electrolyte circulates between the positive electrode liquid tank 100 and the stack unit 300 through a positive electrode pipe 101, and the flow direction of the positive electrolyte may be shown in the direction of the arrow of the positive electrode pipe 101 in FIG. 1. The negative electrode liquid tank 200 contains a negative electrolyte, the negative electrolyte circulates between the negative electrode liquid tank 200 and the stack unit 300 through a negative electrode pipe 201, and the flow direction of the negative electrolyte may be shown in the direction of the arrow of the negative electrode pipe 201 in FIG. 1. An isolating membrane 301 may be disposed in the stack unit 300 so as to prevent the positive electrolyte and the negative electrolyte from being mixed. The stack unit 300 has a positive electrode (+) and a negative electrode (−) and can be connected to an external power supply or load to implement charging and discharging. Each electrolyte will undergo an oxidation or reduction reaction in the process of flowing through the stack unit 300. In the charging process of the flow battery, the positive electrolyte undergoes an oxidation reaction to increase the valence of the active species, and the negative electrolyte undergoes a reduction reaction to decrease the valence of the active species, and in the discharging process, the opposite is true. Due to the implementation of spatial separation of the electrochemical reaction site (stack unit) and the energy storage active species, and the relatively independent design of battery power and capacity, the flow battery is suitable for energy storage systems for large-scale power storage such as wind power generation and photovoltaic power generation.

The inventors of the present application have found in practice that a large amount of heat will be generated during operation of the flow battery, causing the temperature of the electrolytes to increase, and the electrolytes will crystallize at a high temperature, resulting in a blockage of a flow channel in the stack unit. Using a vanadium redox flow battery as an example, vanadium ions in the electrolytes will generate crystals such as vanadium pentoxide at a high temperature, and these crystals will easily cause a blockage of a flow channel in the stack unit, thereby seriously affecting the service life of the stack unit and the operating efficiency of the flow battery, and after the flow channel of the stack unit is blocked, it can only be cleaned manually, which is costly and inefficient, resulting in poor user experience.

Embodiments of the present application provide a flow battery cleaning apparatus, wherein a flow battery includes: a positive electrode liquid tank, a negative electrode liquid tank, and a stack unit, the positive electrode liquid tank and the stack unit forming a positive electrode circulation loop, and the negative electrode liquid tank and the stack unit forming a negative electrode circulation loop. The flow battery cleaning apparatus includes: a detection apparatus, a first foreign matter removal apparatus, and a second foreign matter removal apparatus, and the detection apparatus includes a first detection apparatus.

The first detection apparatus is configured to detect whether foreign matter is present in the stack unit.

The first foreign matter removal apparatus is configured to adjust the pressure of the positive electrode circulation loop.

The second foreign matter removal apparatus is configured to adjust the pressure of the negative electrode circulation loop.

In the flow battery cleaning apparatus provided by the embodiments of the present application, when the first detection apparatus detects that foreign matter is present in the stack unit, the pressure of the positive electrode circulation loop is adjusted by the first foreign matter removal apparatus, and the pressure of the negative electrode circulation loop is adjusted by the second foreign matter removal apparatus, so that the scouring strength of an electrolyte in the circulation loop to which it belongs can be increased, and thus the foreign matter in the stack unit can be cleaned out. The flow battery cleaning apparatus provided by the embodiments of the present application can promptly detect and clean out foreign matter such as crystals in the stack unit, so that the probability of a blockage occurring in the stack unit can be reduced, long-term stable operation of the flow battery can be ensured, and the maintenance costs of the flow battery can be reduced.

In an exemplary embodiment, the first detection apparatus is configured to detect whether foreign matter is present in the stack unit every time a first time period elapses.

In the present embodiment, the first detection apparatus may be configured to check the stack unit every time the first time period elapses. The operating frequency of the first detection apparatus may be controlled by setting the length of the first time period, so that it can be ensured that continuous operation of the first detection apparatus is avoided while foreign matter in the stack unit is promptly found, facilitating energy saving and ensuring long-term stable operation of the first detection apparatus. The length of the first time period may be set according to requirements, and is not limited in the present application.

In an exemplary embodiment, the first detection apparatus, for example, may be an ultrasonic detector, and the ultrasonic detector can be used to detect whether foreign matter is present in the stack unit and calculate the actual position of the foreign matter, so as to facilitate the control of the operation of the first foreign matter removal apparatus and/or the second foreign matter removal apparatus to scour off the foreign matter in the stack unit.

In an exemplary embodiment, the first detection apparatus, for example, may be a pressure detection apparatus such as a pressure sensor. When foreign matter is present in a flow channel of the stack unit, the flow of an electrolyte will be affected, resulting in a change in a pressure value in the positive electrode circulation loop or the negative electrode circulation loop, and whether foreign matter is present can be determined by detecting the change in the pressure value in the positive electrode circulation loop or the negative electrode circulation loop. In an exemplary embodiment, an influence relationship of parameters such as the size and position of foreign matter on the change in pressure values at different positions in the circulation loops may be established in advance, and at least one pressure detection apparatus is disposed at at least one position of a single circulation loop, so that when a change in the pressure value at a corresponding position in the circulation loop is detected, the first foreign matter removal apparatus or the second foreign matter removal apparatus is controlled to operate to scour off the foreign matter in the stack unit.

In an exemplary embodiment, the first detection apparatus, for example, may be a flow velocity detection apparatus. When foreign matter is present in a flow channel of the stack unit, the flow of an electrolyte will be affected, resulting in a change in the flow velocity in the positive electrode circulation loop or the negative electrode circulation loop, and whether foreign matter is present can be determined by detecting the change in the flow velocity of the liquid in the positive electrode circulation loop or the negative electrode circulation loop. In an exemplary embodiment, an influence relationship of parameters such as the size and position of foreign matter on the change in the flow velocity of a liquid at different positions in the circulation loops may be established in advance, and at least one flow velocity detection apparatus is disposed at at least one position of a single circulation loop, so that when a change in the flow velocity of a liquid at a corresponding position in the circulation loop is detected, the first foreign matter removal apparatus or the second foreign matter removal apparatus is controlled to operate to scour off the foreign matter in the stack unit. In practical applications, the type of the first detection apparatus and the manner of detecting the foreign matter may be selected according to the actual situation, and are not limited in the present application.

In an exemplary embodiment, the detection apparatus further includes a second detection apparatus and a third detection apparatus. The second detection apparatus is configured to detect a first pressure value of the positive electrode circulation loop, and the third detection apparatus is configured to detect a second pressure value of the negative electrode circulation loop. The first foreign matter removal apparatus is configured to adjust the pressure of the positive electrode circulation loop to a third pressure value when the first pressure value is less than a first threshold, the third pressure value being greater than the first pressure value and less than the first threshold. The second foreign matter removal apparatus is configured to adjust the pressure of the negative electrode circulation loop to a fourth pressure value when the second pressure value is less than the first threshold, the fourth pressure value being greater than the second pressure value and less than the first threshold.

In the present embodiment, the first threshold may be set in advance, the first threshold may be the product of a maximum pressure value that the stack unit can bear and a first coefficient, and the first coefficient may be greater than 0 and less than or equal to 1. For example, the first coefficient may be 1, and in this case, the first threshold is the maximum pressure value that the stack unit can bear, and in other embodiments, the first coefficient may be 0.8 or 0.9 and the like, and in this case, the first threshold may be less than the maximum pressure value that the stack unit can bear, so that when the pressure value of the positive electrode circulation loop or the pressure value of the negative electrode circulation loop is adjusted, it can be ensured that no damage will be caused to the stack unit. The first threshold may be set according to actual requirements, and is not limited in the present application.

In an exemplary embodiment, the second detection apparatus, for example, may be a pressure detection apparatus such as a pressure sensor disposed in the positive electrode circulation loop, and can detect the first pressure value of the positive electrode circulation loop. The third detection apparatus, for example, may be a pressure detection apparatus such as a pressure sensor disposed in the negative electrode circulation loop, and can detect the second pressure value of the negative electrode circulation loop. The types of the second detection apparatus and the third detection apparatus are not limited in the present application.

In an exemplary embodiment, the third pressure value and the fourth pressure value are equal.

In an exemplary embodiment, the first foreign matter removal apparatus can gradually adjust the pressure value of the positive electrode circulation loop in stages. A plurality of incremental step values can be differentiated in the process of adjusting the first pressure value to the third pressure value. The pressure value of the positive electrode circulation loop is adjusted to different step value levels in order from small to large and maintained at each step value for a period of time, so as to ensure that the pressure value of the positive electrode circulation loop is increased gradually and stably. For example, the first pressure value is 100 Pa and the third pressure value is 150 Pa, and a first step value of 120 Pa and a second step value of 140 Pa may be set. In the process of adjusting the first pressure value to the third pressure value, the first pressure value 100 Pa of the positive electrode circulation loop is first adjusted to the first step value 120 Pa which is maintained for 30 seconds, then the pressure value of the positive electrode circulation loop is adjusted to the second step value 140 Pa which is maintained for 30 seconds, and then the pressure value of the positive electrode circulation loop is adjusted to the third pressure value 150 Pa, thereby achieving the gradual adjustment of the pressure value of the positive electrode circulation loop. In the process of adjusting the first pressure value to the third pressure value, if disappearance of the foreign matter in the stack unit is detected, the pressure value of the positive electrode circulation loop may be adjusted back to the first pressure value. For example, if it is found that the foreign matter is scoured off within the 30 seconds in which the pressure value of the positive electrode circulation loop is maintained at the first step value of 120 Pa, the positive electrode circulation loop may be adjusted back to the first pressure value of 100 Pa without the need for adjustment at a larger step value. The above numerical examples are merely illustrative and do not represent actual numerical levels, and the differentiation of the step values and the retention time of each step value may be set according to requirements, and are not limited in the present application. The operating process of the second foreign matter removal apparatus may be similar to that of the first foreign matter removal apparatus, and will not be repeated herein.

In an exemplary embodiment, a first function relationship between the amount of change in pressure and the time may be set in advance, and the first foreign matter removal apparatus can adjust the first pressure value to the third pressure value according to the set function relationship, so that the scouring strength of the electrolyte in the pressure adjustment process can be controlled. For example, the scouring strength of the electrolyte can be controlled to be different at different stages of the first function, so as to better control the scouring strength for the foreign matter, improving the foreign matter removal effect. In an exemplary embodiment, the first function relationship between the amount of change in pressure ΔP and the time t may be set in advance as a linear function, or a quadratic function, or a combination of different function relationships. In practical applications, suitable function relationships and specific parameters may be set according to requirements, and are not limited in the present application. For the pressure adjustment process of the second foreign matter removal apparatus, reference may be made to the description of the first foreign matter removal apparatus, which will not be repeated herein.

In an exemplary embodiment, the first foreign matter removal apparatus, for example, may be an electric valve, and the pressure value of the positive electrode circulation loop can be adjusted by controlling the opening and closing of the electric valve. Alternatively, the first foreign matter removal apparatus may be a variable frequency pump, and the pressure value of the positive electrode circulation loop may be adjusted by adjusting the flow velocity of the electrolyte in the positive electrode circulation loop. For the type of the second foreign matter removal apparatus, reference may be made to the description of the first foreign matter removal apparatus, which will not be repeated herein. The types of the first foreign matter removal apparatus and the second foreign matter removal apparatus may be set according to requirements, and are not limited in the present application.

In an exemplary embodiment, the flow battery cleaning apparatus further includes a first filter apparatus and a second filter apparatus. The first filter apparatus is connected to the positive electrode circulation loop and configured to prevent the foreign matter from entering the positive electrode liquid tank, and the second filter apparatus is connected to the negative electrode circulation loop and configured to prevent the foreign matter from entering the negative electrode liquid tank.

In the present embodiment, by providing the first filter apparatus and the second filter apparatus, the scoured foreign matter will not enter the positive electrode liquid tank and the negative electrode liquid tank. After the foreign matter is scoured off, the foreign matter can be taken out simply by cleaning the first filter apparatus and the second filter apparatus, without the need for disassembly of the flow battery, thereby facilitating stable long-term operation of the flow battery.

In an exemplary embodiment, the first filter apparatus and the second filter apparatus, for example, may be a Y-type filter, and the types of the filter apparatuses are not limited in the present application.

In an exemplary embodiment, the flow battery cleaning apparatus further includes a first switch and a second switch. The first switch is disposed on the positive electrode circulation loop and configured to open or close the positive electrode circulation loop, and the second switch is disposed on the negative electrode circulation loop and configured to open or close the negative electrode circulation loop.

In an exemplary embodiment, the flow battery further includes a positive electrode pipe, a positive electrode liquid pump, a negative electrode pipe, and a negative electrode liquid pump.

The positive electrode pipe is connected to the positive electrode liquid tank and the stack unit and configured to form the positive electrode circulation loop between the positive electrode liquid tank and the stack unit.

The positive electrode liquid pump is connected to the positive electrode pipe and configured to circulate the positive electrolyte between the positive electrode liquid tank and the stack unit.

The negative electrode pipe is connected to the negative electrode liquid tank and the stack unit and configured to form a loop between the negative electrode liquid tank and the stack unit.

The negative electrode liquid pump is connected to the negative electrode pipe and configured to circulate the negative electrolyte between the negative electrode liquid tank and the stack unit.

In an exemplary embodiment, the positive electrode liquid pump and the negative electrode liquid pump can have a function of adjusting the pressure and the flow velocity of the electrolytes. For example, the positive electrode liquid pump and the negative electrode liquid pump may each be a variable-frequency pump. The types of the positive electrode liquid pump and the negative electrode liquid pump are not limited in the embodiments of the present application.

In an exemplary embodiment, the stack unit is configured to provide electrochemical reaction sites to the positive electrolyte and the negative electrolyte, respectively.

In an exemplary embodiment, the first switch is disposed on the positive electrode pipe between the positive electrode liquid pump and the positive electrode liquid tank and configured to open or close the positive electrode pipe. The second switch is disposed on the negative electrode pipe between the negative electrode liquid pump and the negative electrode liquid tank and configured to open or close the negative electrode pipe.

In an exemplary embodiment, the first switch and the second switch may each be an electric valve, and are is not limited in the present application.

In the present embodiment, by providing the first switch, the positive electrode pipe can be closed when the positive electrode liquid pump fails, so as to prevent the positive electrolyte from flowing out of the positive electrode liquid tank, facilitating replacement or maintenance of the positive electrode liquid pump. By providing the second switch, the negative electrode pipe can be closed when the negative electrode liquid pump fails, so as to prevent the negative electrolyte from flowing out of the negative electrode liquid tank, facilitating replacement or maintenance of the negative electrode liquid pump.

In an exemplary embodiment, the detection apparatus further includes a fourth detection apparatus. The fourth detection apparatus is configured to detect whether the operating state of the flow battery is normal before the first detection apparatus detects whether foreign matter is present in the stack unit.

In an exemplary embodiment, the flow battery cleaning apparatus further includes a display apparatus, configured to display whether the operating state of the flow battery is normal according to the detection result of the fourth detection apparatus. In an exemplary embodiment, the display apparatus can perform a display operation only when the operating state of the flow battery is abnormal. The display apparatus may include a display screen.

In an exemplary embodiment, the flow battery cleaning apparatus further includes a fifth detection apparatus. The fifth detection apparatus is configured to detect whether the operating state of the stack unit is normal before the first detection apparatus detects whether foreign matter is present in the stack unit.

In an exemplary embodiment, the display apparatus is further configured to display whether the operating state of the stack unit is normal according to the detection result of the fifth detection apparatus. In an exemplary embodiment, the display apparatus can perform a display operation only when the operating state of the stack unit is abnormal.

In an exemplary embodiment, the display apparatus is further configured to display the operating state of the flow battery cleaning apparatus and the operating state of the flow battery, and the present application is not limited thereto.

In an exemplary embodiment, the flow battery cleaning apparatus further includes an automatic control apparatus. The automatic control apparatus is configured to control the first foreign matter removal apparatus, the second foreign matter removal apparatus, and the display apparatus to operate according to the detection result of the detection apparatus.

FIG. 2 is a schematic diagram of a flow battery cleaning apparatus in an exemplary embodiment. As shown in FIG. 2, the flow battery includes a positive electrode liquid tank 1, a negative electrode liquid tank 7, and a stack unit 5. The positive electrode liquid tank 1 has a liquid outlet and a liquid inlet. The stack unit 5 has a positive electrode liquid inlet and a positive electrode liquid outlet, a positive electrode liquid flow channel being provided between the positive electrode liquid inlet and the positive electrode liquid outlet. A positive electrode pipe 4 is disposed between the positive electrode liquid tank 1 and the stack unit 5, and the positive electrode pipe 4 connects the liquid outlet of the positive electrode liquid tank 1 to the positive electrode liquid inlet of the stack unit 5 and connects the positive electrode liquid outlet of the stack unit 5 to the liquid inlet of the positive electrode liquid tank 1, so that a positive electrode circulation loop is formed between the positive electrode liquid tank 1 and the stack unit 5. A positive electrode liquid pump 3 is disposed on the positive electrode pipe 4 between the liquid outlet of the positive electrode liquid tank 1 and the positive electrode liquid inlet of the stack unit 5, and a positive electrolyte circulates between the positive electrode liquid tank 1, the positive electrode pipe 4, and the positive electrode liquid flow channel of the stack unit 5 under the action of the positive electrode liquid pump 3, and the direction of the hollow arrow on the positive electrode pipe 4 is the flow direction of the positive electrolyte. The negative electrode liquid tank 7 also has a liquid outlet and a liquid inlet. The stack unit 5 has a negative electrode liquid inlet and a negative electrode liquid outlet, a negative electrode liquid flow channel being provided between the negative electrode liquid inlet and the negative electrode liquid outlet. A negative electrode pipe 10 is disposed between the negative electrode liquid tank 7 and the stack unit 5, and the negative electrode pipe 10 connects the liquid outlet of the negative electrode liquid tank 7 to the negative electrode liquid inlet of the stack unit 5 and connects the negative electrode liquid outlet of the stack unit 5 to the liquid inlet of the negative electrode liquid tank 7, so that a negative electrode circulation loop is formed between the negative electrode liquid tank 7 and the stack unit 5. A negative electrode liquid pump 9 is disposed on the negative electrode pipe 10 between the liquid outlet of the negative electrode liquid tank 7 and the negative electrode liquid inlet of the stack unit 5, and a negative electrolyte circulates between the negative electrode liquid tank 7, the negative electrode pipe 10, and the negative electrode liquid flow channel of the stack unit 5 under the action of the negative electrode liquid pump 9, and the direction of the hollow arrow on the negative electrode pipe 10 is the flow direction of the negative electrolyte.

As shown in FIG. 2, the flow battery cleaning apparatus includes: a detection apparatus, a first foreign matter removal apparatus 6, and a second foreign matter removal apparatus 11. The detection apparatus may include a first detection apparatus 12, and the first detection apparatus 12 may be connected to the stack unit 5 and configured to detect whether foreign matter is present in the stack unit 5. The first foreign matter removal apparatus 6 may be mounted between the positive electrode liquid outlet of the stack unit 5 and the liquid inlet of the positive electrode liquid tank 1, and is configured to adjust the pressure of the positive electrode circulation loop. The second foreign matter removal apparatus 11 may be mounted between the negative electrode liquid outlet of the stack unit 5 and the liquid inlet of the negative electrode liquid tank 7 and configured to adjust the pressure of the negative electrode circulation loop.

In an exemplary embodiment, the first detection apparatus 12 may be an ultrasonic detector. A timer may be used to record the time when the ultrasonic detector emits a sound wave and the time when the return sound wave is received, and the time difference t between the time when the sound wave is emitted and the time when the return sound wave is received is the propagation time of the sound wave, which is combined with the propagation velocity of the sound wave to calculate the distance between a sound wave emitting point and an obstacle. For example, assuming that the propagation velocity of the ultrasonic wave in air is 340 m/sec, and the time difference between the time when the ultrasonic detector emits the sound wave and the time when the return sound wave is received is t, the distance s between the sound wave emitting point and the obstacle can be calculated according to the following formula 1:

$$s = 3 \; 40 t / 2 = 1 \; 70 t , \qquad formula 1$$

From formula 1, the actual position of the foreign matter in the stack unit can be determined, facilitating accurate location of the fault point. For example, if it can be determined that the foreign matter is located in the positive electrode liquid flow channel or the negative electrode liquid flow channel of the stack unit, the foreign matter can be removed by the first foreign matter removal apparatus or the second foreign matter removal apparatus.

In an exemplary embodiment, the ultrasonic detector may be configured to be turned on every time a first time period t1 elapses to perform foreign matter detection on the stack unit 5.

In an exemplary embodiment, the first foreign matter removal apparatus 6 and the second foreign matter removal apparatus 11 may each be an electric valve, and the present application is not limited thereto.

In an exemplary embodiment, the detection apparatus further includes: a second detection apparatus 14 and a third detection apparatus 16. The second detection apparatus 14 may be disposed on the positive electrode pipe 4 between the positive electrode liquid pump 3 and the positive electrode liquid inlet of the stack unit 5 and configured to detect a first pressure value of the positive electrode circulation loop. The third detection apparatus 16 may be provided on the negative electrode pipe 10 between the negative electrode liquid pump 9 and the negative electrode liquid inlet of the stack unit 5 and configured to detect a second pressure value of the negative electrode circulation loop.

In an exemplary embodiment, the second detection apparatus 14 may be a pressure sensor, and may be connected to the positive electrode pipe 4 by a first valve 13. The third detection apparatus 16 may be a pressure sensor, and may be connected to the negative electrode pipe 10 by a second valve 15.

In an exemplary embodiment, the pressure value of the positive electrode circulation loop and the pressure value of the negative electrode circulation loop may be separately adjusted. After determining that foreign matter is present in the stack unit 5, it can be first determined whether the foreign matter is present in the positive electrode liquid flow channel or the negative electrode liquid flow channel. Using, as an example, the foreign matter being located in the positive electrode liquid flow channel, it can be determined whether the first pressure value of the positive electrode circulation loop is currently less than a first threshold. When it is determined that the first pressure value is less than the first threshold, the first foreign matter removal apparatus 6 can be controlled to adjust the pressure value of the positive electrode circulation loop to a third pressure value which is greater than the first pressure value and less than the first threshold, so as to scour the foreign matter in the positive electrode liquid flow channel. Similarly, when the foreign matter is located in the negative electrode liquid flow channel and the second pressure value is less than the first threshold, the second foreign matter removal apparatus 11 can be controlled to adjust the pressure value of the negative electrode circulation loop to a fourth pressure value which is greater than the second pressure value and less than the first threshold, so as to scour the foreign matter in the negative electrode liquid flow channel. In an exemplary embodiment, the first threshold may be a maximum pressure value that the stack unit 5 can bear. In an exemplary embodiment, the fourth pressure value may be equal to the third pressure value.

In an exemplary embodiment, the pressure value of the positive electrode circulation loop and the pressure value of the negative electrode circulation loop may be synchronously adjusted. After determining that foreign matter is present in the stack unit 5 and both the first pressure value and the second pressure value are less than the first threshold, regardless of whether the foreign matter is located in the positive electrode liquid flow channel or the negative electrode liquid flow channel, simultaneously, the first foreign matter removal apparatus 6 is controlled to adjust the pressure value of the positive electrode circulation loop to the third pressure value, and the second foreign matter removal apparatus 11 is controlled to adjust the pressure value of the negative electrode circulation loop to the fourth pressure value, so that the liquid flow conditions of the positive electrode circulation loop and the liquid flow conditions of the negative electrode circulation loop are consistent with each other, and crystallization of the loop at the side having no crystallization at present can also be avoided. In practical applications, the pressure value of the positive electrode circulation loop and the pressure value of the negative electrode circulation loop may be adjusted separately or synchronously according to requirements, and the present application is not limited thereto. In an exemplary embodiment, the first threshold may be the maximum pressure value that the stack unit 5 can bear. In an exemplary embodiment, the fourth pressure value may be equal to the third pressure value. For the details of separate or synchronous adjustment of the pressure value of the positive electrode circulation loop and the pressure value of the negative electrode circulation loop, reference may be made to the description for the above embodiments, which will not be repeated herein.

In an exemplary embodiment, the flow battery cleaning apparatus further includes a first filter apparatus 17 and a second filter apparatus 19. The first filter apparatus 17 may be disposed on the positive electrode pipe 4 between the liquid inlet of the positive electrode liquid tank 1 and the first foreign matter removal apparatus 6, and configured to prevent the foreign matter from entering the positive electrode liquid tank 1. The second filter apparatus 19 may be disposed on the positive electrode pipe 4 between the liquid inlet of the negative electrode liquid tank 7 and the second foreign matter removal apparatus 11, and configured to prevent the foreign matter from entering the negative electrode liquid tank 7.

In an exemplary embodiment, the first filter apparatus 17 may be a Y-type filter. A first end outlet of the Y-type filter is connected to the liquid inlet of the positive electrode liquid tank 1 to allow the filtered positive electrolyte to enter the positive electrode liquid tank 1, and a second end outlet 18 of the Y-type filter is configured to accommodate the filtered foreign matter, and the foreign matter can be taken out by cleaning the second end outlet 18. The second filter apparatus 19 may be a Y-type filter. A first end outlet of the Y-type filter is connected to the liquid inlet of the negative electrode liquid tank 7 to allow the filtered negative electrolyte to enter the negative electrode liquid tank 7, and a second end outlet 20 of the Y-type filter is configured to accommodate the filtered foreign matter, and the foreign matter can be taken out by cleaning the second end outlet 20.

In an exemplary embodiment, the flow battery cleaning apparatus may further include a first switch 2 and a second switch 8. The first switch 2 may be disposed on the positive electrode pipe 4 between the positive electrode liquid pump 3 and the positive electrode liquid tank 1, and the second switch 8 may be disposed on the negative electrode pipe 10 between the negative electrode liquid pump 9 and the negative electrode liquid tank 7. The first switch 2 may be an electric valve so as to close the positive electrode pipe 4 when the positive electrode liquid pump 3 fails, which can prevent the positive electrolyte from flowing out of the positive electrode liquid tank 1, facilitating the replacement or maintenance of the positive electrode liquid pump 3. The second switch 8 may be an electric valve so as to close the negative electrode pipe 10 when the negative electrode liquid pump 9 fails, which can prevent the negative electrolyte from flowing out of the negative electrode liquid tank 7, facilitating the replacement or maintenance of the negative electrode liquid pump 9.

In an exemplary embodiment, the flow battery cleaning apparatus further includes a fourth detection apparatus (not shown in the figure), and the fourth detection apparatus is configured to detect whether the operating state of the flow battery is normal before the first detection apparatus 12 detects whether foreign matter is present in the stack unit.

In an exemplary embodiment, the flow battery cleaning apparatus further includes a fifth detection apparatus (not shown in the figure), and the fifth detection apparatus is configured to detect whether the operating state of the stack unit is normal before the first detection apparatus 12 detects whether foreign matter is present in the stack unit.

In an exemplary embodiment, the flow battery cleaning apparatus may further include a display apparatus (not shown in the figure), and the display apparatus may be configured to display the detection result of the detection apparatus and the operating state of the flow battery cleaning apparatus.

In an exemplary embodiment, the flow battery cleaning apparatus may further include an automatic control apparatus (not shown in the figure), and the automatic control apparatus may be configured to control the first foreign matter removal apparatus, the second foreign matter removal apparatus, and the display apparatus to operate according to the detection result of the detection apparatus, so as to implement the automatic operation of the flow battery cleaning apparatus.

Embodiments of the present application further provide a flow battery cleaning method, wherein a flow battery includes: a positive electrode liquid tank, a negative electrode liquid tank, and a stack unit, the positive electrode liquid tank and the stack unit forming a positive electrode circulation loop, and the negative electrode liquid tank and the stack unit forming a negative electrode circulation loop. The method includes: using a first detection apparatus to detect whether foreign matter is present in the stack unit; using a first foreign matter removal apparatus to remove foreign matter located in the positive electrode circulation loop, the first foreign matter removal apparatus being configured to adjust the pressure of the positive electrode circulation loop; and using a second foreign matter removal apparatus to remove foreign matter located in the negative electrode circulation loop, the second foreign matter removal apparatus being configured to adjust the pressure of the negative electrode circulation loop.

In the flow battery cleaning method provided by the embodiments of the present application, when the first detection apparatus detects that foreign matter is present in the stack unit, the pressure value of the positive electrode circulation loop is adjusted by the first foreign matter removal apparatus, and the pressure value of the negative electrode circulation loop is adjusted by the second foreign matter removal apparatus, so that the scouring strength of an electrolyte in the circulation loop to which it belongs can be increased, and thus the foreign matter in the stack unit can be cleaned out. The flow battery cleaning method provided by the embodiments of the present application can promptly detect and clean out foreign matter such as crystals in the stack unit, so that the probability of a blockage occurring in the stack unit can be reduced, long-term stable operation of the flow battery can be ensured, and the maintenance costs of the flow battery can be reduced.

The flow battery cleaning method provided by the embodiments of the present application is described below in connection with the accompanying drawings.

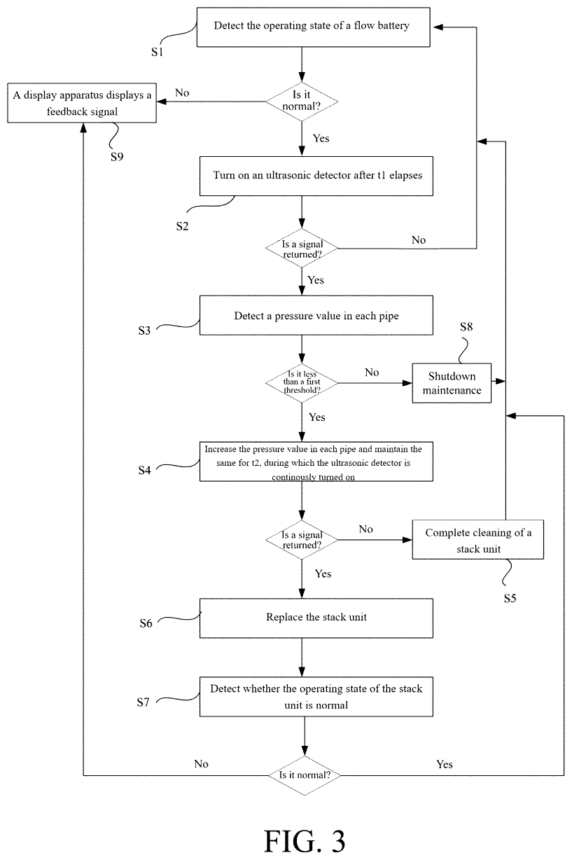

FIG. 3 is a schematic diagram of a cleaning process using the flow battery cleaning apparatus shown in FIG. 2 in an exemplary embodiment. In FIG. 3, the description is given by using, as an example, the first detection apparatus being an ultrasonic detector and the second detection apparatus and the third detection apparatus each being a pressure sensor. As shown in FIG. 3, the cleaning process of the flow battery includes:

S1. detecting the operating state of the flow battery.

Before the flow battery cleaning apparatus formally starts to operate, it should be determined whether the flow battery connected to the cleaning apparatus can operate normally. The operating state of the flow battery may be detected by the fourth detection apparatus. If it is detected that the operating state of the flow battery is abnormal, skip to step S9. When it is detected that the operating state of the flow battery is normal, skip to step S2, where the flow battery cleaning apparatus can formally start to operate.

S2. Turning on the ultrasonic detector after t1 elapses.

In an exemplary embodiment, the ultrasonic detector may be configured to automatically return a signal to the automatic control apparatus after detecting the foreign matter, and not return a signal if no foreign matter is detected. The ultrasonic detector may be turned on every time the first time period t1 elapses to ultrasonically check the stack unit, and it is determined whether the ultrasonic detector returns a signal. When the ultrasonic detector returns a signal, skip to step S3. When the ultrasonic detector does not return a signal, it means that no foreign matter is present in the stack unit, and return to step S1. In other embodiments, the ultrasonic detector may be continuously kept turned on, and whether the ultrasonic detector returns a signal is detected every time the first time period t1 elapses, and the present application is not limited thereto. S3. Detecting the pressure value in each pipe.

In an exemplary embodiment, when the ultrasonic detector detects that foreign matter is present in the stack unit, the first pressure value of the positive electrode circulation loop detected by the second detection apparatus and the second pressure value of the negative electrode circulation loop detected by the third detection apparatus are read, and it is determined whether the first pressure value is less than the first threshold and the second pressure value is less than the first threshold. When it is determined that the first pressure value is greater than or equal to the first threshold or that the second pressure value is greater than or equal to the first threshold, skip to step S8. When it is determined that the first pressure value is less than the first threshold and the second pressure value is less than the first threshold, skip to step S4.

S4. Increasing the pressure value in each pipe and maintaining the same for t2, during which the ultrasonic detector is continuously turned on.

In an exemplary embodiment, when the first pressure value is less than the first threshold and the second pressure value is less than the first threshold, it means that the pressure value in each pipe is still maintained at a normal level, and the foreign matter may be scoured off by adjusting the pressure. The first foreign matter removal apparatus may be controlled to adjust the pressure value of the positive electrode circulation loop to the third pressure value, and the third pressure value is maintained within at least the second time period t2, the third pressure value being greater than the first pressure value and less than the first threshold. The second foreign matter removal apparatus may be controlled to adjust the pressure value of the negative electrode circulation loop to the fourth pressure value, and the third pressure value is maintained within at least the second time period t2, the fourth pressure value being greater than the second pressure value and less than the first threshold. The pressure of the positive electrode circulation loop and the pressure of the negative electrode circulation loop may be adjusted separately or synchronously, and the ultrasonic detector is continuously kept turned on during the process of increasing the pressure value of each pipe and during the second time period t2 after the pressure value is increased, so as to monitor whether the foreign matter is removed. By adjusting the pressure values in the positive electrode circulation loop and the negative electrode circulation loop, the pressures of electrolyte flows are increased, and the impact force generated by the electrolyte flows becomes larger, so that the foreign matter in the stack unit can be scoured off. For the specific adjustment manner and adjustment process, reference may be made to the description in the above embodiments, which will not be repeated herein.

In other embodiments, the ultrasonic detector may be configured to not operate continuously, but to be turned on for detection after the pressure values in the positive electrode circulation loop and the negative electrode circulation loop are adjusted and the pressure values are maintained for operation for the second time period t2. Even if the foreign matter is scoured off during pressure adjustment, the high-speed scouring of the positive electrode circulation loop and the negative electrode circulation loop by the electrolytes can still be maintained for the second time period, thereby ensuring that the foreign matter is cleaned out more thoroughly.

After step S4, when it is determined that the ultrasonic detector no longer returns a signal, skip to step S5. When it is determined that the ultrasonic detector still returns a signal, skip to step S6.

S5. Completing the cleaning of the stack unit.

Since the ultrasonic detector no longer returns a signal, it can be determined that the foreign matter has been removed, and then skip to step S1.

In an exemplary embodiment, after the cleaning of the stack unit is completed, the foreign matter will be captured by the first filter apparatus or the second filter apparatus, and the first filter apparatus and the second filter apparatus may be cleaned. When the first filter apparatus and the second filter apparatus are Y-type filters, the filtered foreign matter may be cleaned out directly from the second end outlet of each Y-type filter.

In an exemplary embodiment, it may be arranged that the first filter apparatus or the second filter apparatus is cleaned once after the stack unit is cleaned multiple times. In an exemplary embodiment, the threshold number of times may be set in advance, the first filter apparatus or the second filter apparatus is cleaned once after the number of times the stack unit is cleaned reaches the threshold number of times, and the size of the threshold number of times may be set according to requirements, and is not limited in the present application. For example, the automatic control apparatus may record the current number of times the stack unit has been cleaned, and may collect the number of times the positive electrode circulation loop and the negative electrode circulation loop have been cleaned, respectively. The first filter apparatus is cleaned once after the number of times the positive electrode circulation loop has been cleaned reaches the set threshold number of times, and the second filter apparatus is cleaned once after the number of times the negative electrode circulation loop has been cleaned reaches the set threshold number of times. The threshold number of times of the positive electrode circulation loop and the threshold number of times of the negative electrode circulation loop may be the same or different. The automatic control apparatus may display the relevant information (the number of times the stack unit has been cleaned and the time of each cleaning, the threshold number of times, and the last cleaning time of the filter apparatuses) on the display apparatus, facilitating the cleaning operation of operators. Content such as the specific operation for cleaning the first filter apparatus or the second filter apparatus and the means of notification may be set according to requirements, and are not limited in the present application.

S6. Replacing the stack unit.

Because the ultrasonic detector continuously returns a signal, it can be determined that the foreign matter cannot be removed and only the stack unit can be replaced. Skip to step S7 after the stack unit is replaced.

S7. Detecting whether the operating state of the stack unit is normal.

In an exemplary embodiment, the operating state of the stack unit may be detected by the fifth detection apparatus, and when the operating state of the stack unit is normal, skip to step S1. When the operating state of the stack unit is abnormal, skip to step S9.

S8. Performing shutdown maintenance.

When it is determined that the first pressure value is greater than or equal to the first threshold or that the second pressure value is greater than or equal to the first threshold, it means that the operating pressure of the flow battery itself is excessive, and shutdown maintenance is required. After the shutdown maintenance is completed, skip to step S1.

S9. Displaying, by the display apparatus, a feedback signal.

A first feedback signal is generated when the operating state of the flow battery is abnormal, and the detected abnormal state is displayed on the display apparatus, so that the operator can further check the source of the fault.

A second feedback signal is generated when the operating state of the stack unit is abnormal, and the detected abnormal state is displayed on the display apparatus, so that the operator can further check the source of the fault.

In an exemplary embodiment, the processing states of the above steps S2 to S6 and S8 may also be displayed on the display apparatus. For example, after every time the ultrasonic detector is turned on in step S2, a corresponding detection result may be displayed. After the pressure value in each pipe is detected in step S3, the display apparatus may display the current pressure values in the positive electrode pipe and the negative electrode pipe. During the process of increasing the pressure value in each pipe in step S4, the level of the pressure value in the pipe can be updated in real time and an alert of the detection result of the ultrasonic detector is provided. In step S5, it can be displayed that the cleaning of the stack unit is completed, so that the operator can know the operating condition of the flow battery. In step S6, an alert can be provided that the stack unit is currently being replaced. In step S8, an alert can be provided that shutdown maintenance is currently being performed. The display content of the display apparatus may be set according to requirements, and is not limited in the present application.

The flow battery cleaning method provided by the embodiments of the present application is applied to the flow battery cleaning apparatus in the above embodiments, and for the functions and effects of the steps, reference may be made to the description of the flow battery cleaning apparatus, which will not be repeated herein.

Embodiments of the present application further provide a flow battery cleaning system, including a flow battery and the flow battery cleaning apparatus in the above embodiments.

Although the embodiments of the present invention are disclosed as above, the contents described are only embodiments adopted to facilitate understanding of the present invention and are not intended to limit the present invention. Any modifications and changes in the form and details of implementation may be made by any person skilled in the art of the present invention without departing from the spirit and scope disclosed by the present invention.

1. A flow battery cleaning apparatus, wherein a flow battery comprises: a positive electrode liquid tank, a negative electrode liquid tank, and a stack unit, the positive electrode liquid tank and the stack unit forming a positive electrode circulation loop, and the negative electrode liquid tank and the stack unit forming a negative electrode circulation loop; characterized in that the flow battery cleaning apparatus comprises: a detection apparatus, a first foreign matter removal apparatus, and a second foreign matter removal apparatus, and the detection apparatus comprises a first detection apparatus;
the first detection apparatus is configured to detect whether foreign matter is present in the stack unit;
the first foreign matter removal apparatus is configured to adjust the pressure of the positive electrode circulation loop; and
the second foreign matter removal apparatus is configured to adjust the pressure of the negative electrode circulation loop.

2. The flow battery cleaning apparatus according to claim 1, wherein the first detection apparatus is configured to detect whether foreign matter is present in the stack unit every time a first time period elapses.

3. The flow battery cleaning apparatus according to claim 1, wherein the detection apparatus further comprises a second detection apparatus and a third detection apparatus;
the second detection apparatus is configured to detect a first pressure value of the positive electrode circulation loop, and the third detection apparatus is configured to detect a second pressure value of the negative electrode circulation loop;
the first foreign matter removal apparatus is configured to adjust the pressure of the positive electrode circulation loop to a third pressure value when the first pressure value is less than a first threshold, the third pressure value being greater than the first pressure value and less than the first threshold; and
the second foreign matter removal apparatus is configured to adjust the pressure of the negative electrode circulation loop to a fourth pressure value when the second pressure value is less than the first threshold, the fourth pressure value being greater than the second pressure value and less than the first threshold.

4. The flow battery cleaning apparatus according to claim 1, further comprising a first switch and a second switch, the first switch being disposed on the positive electrode circulation loop and configured to open or close the positive electrode circulation loop; and the second switch being disposed on the negative electrode circulation loop and configured to open or close the negative electrode circulation loop.

5. The flow battery cleaning apparatus according to claim 1, further comprising a first filter apparatus and a second filter apparatus;
the first filter apparatus is connected to the positive electrode circulation loop and configured to prevent the foreign matter from entering the positive electrode liquid tank; and the second filter apparatus is connected to the negative electrode circulation loop and configured to prevent the foreign matter from entering the negative electrode liquid tank.

6. The flow battery cleaning apparatus according to claim 5, wherein the detection apparatus further comprises a fourth detection apparatus, the fourth detection apparatus being configured to detect whether the operating state of the flow battery is normal before the first detection apparatus detects whether foreign matter is present in the stack unit.

7. The flow battery cleaning apparatus according to claim 6, further comprising a display apparatus; and the display apparatus is configured to display whether the operating state of the flow battery is normal according to the detection result of the fourth detection apparatus.

8. The flow battery cleaning apparatus according to claim 1, further comprising an automatic control apparatus; and
the automatic control apparatus is configured to control the first foreign matter removal apparatus, the second foreign matter removal apparatus, and a display apparatus to operate according to the detection result of the detection apparatus.

9. A flow battery cleaning method, characterized in that a flow battery comprises: a positive electrode liquid tank, a negative electrode liquid tank, and a stack unit, the positive electrode liquid tank and the stack unit forming a positive electrode circulation loop, and the negative electrode liquid tank and the stack unit forming a negative electrode circulation loop; and the method comprises:
using a first detection apparatus to detect whether foreign matter is present in the stack unit;
using a first foreign matter removal apparatus to remove foreign matter located in the positive electrode circulation loop, the first foreign matter removal apparatus being configured to adjust the pressure of the positive electrode circulation loop; and
using a second foreign matter removal apparatus to remove foreign matter located in the negative electrode circulation loop, the second foreign matter removal apparatus being configured to adjust the pressure of the negative electrode circulation loop.

10. A flow battery cleaning system, characterized by comprising a flow battery and the flow battery cleaning apparatus according to claim 1.
